(19) United States
(12) Patent Application Publication
(10) Pub. No.: US 2024/0032574 A1
(43) Pub. Date: Feb. 1, 2024

(54) COWPEA-BASED PROTEIN CONCENTRATES FOR FOOD PRODUCTS AND METHOD OF MANUFACTURE

(71) Applicant: Smitha Devigere Prabhakar, Bangalore (IN)

(72) Inventor: Smitha Devigere Prabhakar, Bangalore (IN)

(21) Appl. No.: 18/255,898

(22) PCT Filed: Nov. 25, 2021
(86) PCT No.: PCT/IB2021/060974

§ 371 Date: Jun. 5, 2023

(30) Foreign Application Priority Data
Dec. 5, 2020 (IN) 202041053009

(51) Int. Cl. A23L 15/00; A23J 1/14; A23J 3/14; A23J 3/22

(52) U.S. Cl. CPC A23L 15/35; A23J 1/14; A23J 3/14; A23J 3/227

(57) ABSTRACT

The present disclosure provides plant-derived protein-rich concentrates for use as a plant-based whole egg and/or egg-white substitute in various industries including food preparation, pharmaceuticals, and cosmetics. Specifically, the disclosure is directed to a method of manufacturing cowpea-derived protein-rich concentrates and also provides edible compositions comprising the said protein-rich concentrates. The plant-based substitute of the present disclosure overcomes the deficiencies in the art by alleviating the disadvantages associated with the use of normal eggs.

### FIELD OF THE INVENTION

The present disclosure relates generally to the field of plant-derived protein-rich concentrates and methods of manufacturing the same. More specifically, the disclosure is directed to a cowpea-based composition for use as whole egg or egg-white substitute, in edible and non-edible compositions.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Eggs are an inordinate source of protein, vitamins, iron and other nutrients, and are widely consumed around the world. Additionally, eggs are also widely used in a variety of culinary applications, including baking, savory, sweet and cooking since they provide a wide range of gastronomic properties, such as emulsifying, foaming, leavening, thickening, binding, coagulating, moisturizing and the like.

Nowadays, plant-based proteins such as soy and pea as animal protein substitutes have gained enormous attention as consumers seek replacements to conventional animal-derived products. However, there are still challenges that need to be addressed including the replication of gastronomic properties devoid of flavors.

Additionally, the industrial scale production of eggs is associated with industrial farming of chickens that incur high costs, such as, costs related to food health and safety restrictions for farmers, high transportation costs, and the cost of feeding and housing egg-laying birds.

Efforts have been made to manufacture egg substitutes with the desired nutritional and organoleptic properties of normal eggs. Some examples are mashed bananas and/or apple sauce to replace eggs in baking, baking powder/baking soda mixtures to provide leavening, flour/water mixtures to provide binding and leavening. Also, numerous substitutes are commercially available these days. However, the drawback of such substitutes is that they provide any one of the properties of eggs in cooking. For example, mashed fruit provides moisture and binding but not leavening, baking powder/soda and flour/water substitutes provide some leavening but limited binding properties. Eggbeaters is made from real egg-whites, and is thus associated with low shelf life and risk of carrying pathogens, and is also avoided by vegans. Some of the vegan egg substitutes act as imperfect substitutes for many baking purposes because of its inferior binding qualities.

The present disclosure overcomes the deficiencies of the art by providing a method of manufacturing plant-based egg-white substitute and their use in edible compositions.

### OBJECTS OF THE INVENTION

An object of the present disclosure is to provide a method of manufacturing plant-based whole egg or egg-white substitute that satisfies the existing needs, as well as emerging ones, and generally overcomes the deficiencies found in the prior art.

An object of the present disclosure is to provide a plant-based whole egg substitute that has a nutritional profile similar to egg and replicates one or more, if not all, of the egg's core functionalities.

An object of the present disclosure is to provide a plant-based egg-white substitute that has a nutritional profile similar to egg-white and replicates one or more, if not all, of the egg-white's core functionalities.

An object of the present disclosure is to provide a plant-based egg-white substitute that has lower cholesterol but higher albumin and globulin protein levels than the normal eggs.

An object of the present disclosure is to provide a plant-based egg-white substitute that is cost-effective and economic.

An object of the present disclosure is to provide a plant-based whole egg substitute, wherein the substitute is produced from cowpea (Vigna unguiculata).

An object of the present disclosure is to provide a plant-based egg-white substitute, wherein the substitute is produced from cowpea (Vigna unguiculata).

Another object of the present disclosure is to provide a method of manufacturing cowpea-based whole egg substitute.

Another object of the present disclosure is to provide a method of manufacturing cowpea-based egg-white substitute.

Yet another object of the present invention is to provide edible and non-edible products produced using cowpea-based whole egg substitute.

Yet another object of the present invention is to provide edible and non-edible products produced using cowpea-based egg-white substitute.

### SUMMARY OF THE INVENTION

The present disclosure relates to a plant-derived protein-rich concentrate for use as whole egg substitute and method of manufacturing the same. The said substitute has a nutritional profile similar to egg, and replicates one or more, if not all, of the egg's core functionalities.

The present disclosure relates to a plant-derived protein-rich concentrate for use as egg-white substitute and method of manufacturing the same. The said substitute has a nutritional profile similar to egg-white, and replicates one or more, if not all, of the egg-white's core functionalities.

In an aspect, the present disclosure relates to a method of manufacturing plant-based whole egg and/or egg-white substitute that exhibit high functionality for a broad range of edible and non-edible compositions.

In an aspect, the present disclosure relates to a method of manufacturing plant-based whole egg and/or egg-white substitute comprising the steps of: (i) extraction of one or more proteins from cowpea using only water; (ii) separation of fiber and starch using size separation methods; (iii) purification of the protein-rich concentrates/concentrates; (iv) concentrating the protein rich part; (v) Spray drying the protein rich fraction.

In another aspect, the present disclosure relates to cowpea-derived protein-rich concentrates for use as whole egg and/or egg-white substitute for a broad range of edible and non-edible compositions.

In another aspect, the present disclosure relates to a method of manufacturing cowpea-derived protein-rich concentrates comprising extraction of protein-rich concentrates having functional proteins from cowpea without effecting their structure and functions of said proteins.

In an embodiment, cowpea-based whole egg and/or egg-white substitute that has a nutritional profile similar to normal egg, and replicates one or more, if not all, of the egg's core functionalities.

In an embodiment, plant-based whole egg and/or egg-white substitute is characterized by comprising a cholesterol value lower than normal eggs but higher albumin and globulin levels than the normal eggs.

In an aspect, the present disclosure relates to a method of manufacturing plant-based whole egg and/or egg-white substitute from cowpea comprising the steps of: (i) extraction of one or more proteins from cowpea using only water (ii) separation of fiber and starch using size separation methods; (iii) purification of the protein-rich concentrates/concentrates; (iv) concentrating the protein rich part; (v) Spray drying the protein rich fraction.

In an embodiment, the present disclosure relates to a method of manufacturing plant-based whole egg and/or egg-white substitute that reduces the effects on the environment caused by the production of normal eggs.

In another embodiment, the present disclosure relates to a composition of plant-based whole egg and/or egg-white substitute from cowpea for use in edible and non-edible products.

In another embodiment, the present disclosure relates to composition comprising of cowpea-based whole egg and/or egg-white substitute.

In yet another embodiment of the present invention, the composition is edible or non-edible products.

In yet another embodiment of the present invention, the present disclosure relates to composition comprising of cowpea-based concentrate that is substitute for meat.

In another aspect of the present invention, plant-based whole egg and/or egg-white substitute that is cost-effective and economic.

Other aspects of the invention will be set forth in the description which follows, and in part will be apparent from the description, or may be learnt by the practice of the invention.

### BRIEF DESCRIPTION OF DRAWINGS THE INVENTION

The following drawings form part of the present specification and are included to further illustrate aspects of the present disclosure. The disclosure may be better understood by reference to the drawings in combination with the detailed description of the specific embodiments presented herein.

FIG. 1: Image of scrambled food preparation using protein rich cowpea-derived protein-rich concentrate

FIG. 2: Image of cupcake prepared using 2% protein rich cowpea-derived protein-rich concentrate compared to cupcake prepared using egg white.

FIG. 3: Image of omelet prepared using protein rich cowpea-derived protein-rich concentrate

FIG. 4: Image of functional protein (4% solution in water)

FIG. 5: Image of protein solubility (2% protein concentrate in water)

FIG. 6: Image of biscuits prepared using protein rich cowpea-derived protein-rich concentrate.

FIG. 7: Image of raw protein rich cowpea-derived protein-rich concentrate

### DETAILED DESCRIPTION OF THE INVENTION

The following is a detailed description of embodiments of the disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as will be defined by the claims.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some embodiments, numbers have been used for quantifying weights, percentages, ratios, and so forth, to describe and claim certain embodiments of the invention and are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Various terms as used herein are shown below. To the extent a term used in a claim is not defined below, it should be given the broadest definition persons in the pertinent art have given that term as reflected in printed publications and issued patents at the time of filing.

As used in the description herein and throughout the claims that follow, the meaning of “a,” “an,” and “the” includes plural reference unless the context clearly dictates otherwise.

Also, as used in the description herein, the meaning of “in” includes “in” and “on” unless the context clearly dictates otherwise.

Unless the context requires otherwise, throughout the specification which follow, the word “comprise” and variations thereof, such as, “comprises” and “comprising” are to be construed in an open, inclusive sense that is as “including, but not limited to.”

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified.

The description that follows, and the embodiments described therein, is provided by way of illustration of an example, or examples, of particular embodiments of the principles and aspects of the present disclosure. These examples are provided for the purposes of explanation, and not of limitation, of those principles and of the disclosure.

It should also be appreciated that the present disclosure can be implemented in numerous ways, including as a system, a method or a device. In this specification, these implementations, or any other form that the invention may take, may be referred to as processes. In general, the order of the steps of the disclosed processes may be altered within the scope of the invention.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As described herein, the term ‘cowpea’ and ‘Vigna unguiculata’ have been used interchangeably and the meaning of the terms are those as present in the state of the art. The terms denote the annual herbaceous legume from the genus Vigna. They are also known by the names black-eye pea, southern pea, niebe (alternatively n̅ebbe), and crowder pea.

As described herein, the term ‘food’ and ‘edible’ have been used interchangeably and the meaning of the terms are those as present in the state of the art. The terms denote the preparations that can be consumed by humans, animals or any other living organism.

As described herein, the term ‘isolate’ and ‘concentrate’ have been used interchangeably and the meaning of the terms are those as present in the state of the art. The terms denote the preparations that are derived from plants.

As described herein, the term ‘protein’, ‘peptide’ and ‘polypeptide’ have been used interchangeably and the meaning of the terms are those as present in the state of the art. The terms denote the large molecules made up of various amino acids.

In an embodiment, the present disclosure focuses on a plant-derived protein-rich concentrates for use as whole egg and/or egg-white substitute and method of manufacturing the same. The said egg substitute has a nutritional profile similar to eggs, and replicates one or more, if not all, of the egg's core functionalities.

In an embodiment, the term “eggs” includes but is not limited to chicken eggs, other bird eggs (such as quail eggs, duck eggs, ostrich eggs, turkey eggs, bantam eggs, goose eggs), and fish eggs such as fish roe. Typical food application comparison is made with respect to chicken eggs.

In an embodiment, the “plant-derived protein-rich concentrates” refers to whole plant material such as whole plant, or from an intermediate material made from the plant, for example, a dehulled seeds, a flour, a powder, a meal, ground grains, a cake (such as, for example, a defatted or de-oiled cake), or any other intermediate material suitable to the processing techniques disclosed herein to produce a purified protein-rich concentrate. In another embodiment, intermediate material may be a combination or more than two intermediate materials.

In an embodiment, the “plant-derived protein-rich concentrates” are suitable for various edible compositions and can be been incorporated into, egg-based products including but not limited to edible egg-free emulsion, egg analog, egg-free scrambled eggs, egg-free patty, egg-free pound cake, egg-free angel food cake, egg-free yellow cake, egg- and dairy-free cream cheese, egg-free pasta dough, egg-free custard, egg-free ice cream, and dairy-free milk and milk products the like.

In an embodiment, the “plant-derived protein-rich concentrates” are suitable for use as plant-based egg-white substitutes for consumable products including but not limited to cream cheese, pasta dough, pasta, milk or milk-like beverage, a food product comprising said milk or milk-like beverage, custard, ice cream, frozen dessert, meat replicas (e.g., deli meat replicas; emulsified extruded meats (e.g., sausages, fish cake replicas); dips, fillings and spreads, chips, and crackers and the like.

In an embodiment, the “plant-derived protein-rich concentrates” are suitable for use as a recipe for a beverage that required egg whites as an ingredient. The beverage can be either alcoholic or non-alcoholic and can include hot or cold beverages including but not limited to cocktail recipes, mocktails, beers, coffee, cappuccino, and the like.

In an embodiment, the “plant-derived protein-rich concentrates” comprising one or more desirable food qualities, including but not limited to, high protein content, low cholesterol content, reduced retention of oils and lipids, superior structure building properties such as high gel strength and gel elasticity, superior sensory properties, and selective enrichment of highly functional albumin and globulin proteins.

In a preferred embodiment, the present disclosure provides a cowpea-derived protein-rich concentrates for use as whole egg and/or egg-white substitute and method of manufacturing the same. The said substitute has a nutritional profile similar to eggs, and replicates one or more, if not all, of the egg's core functionalities.

In an embodiment, cowpea-derived protein-rich concentrates can be derived from any source of cowpea regardless of cultivar and/or variety.

In an embodiment, the cowpea-derived protein-rich concentrates can be prepared from any part of the cowpea plant including but not limited to whole cowpea, leaves, stem or intermediate products from the plant, including but not limited to a dehulled pea, a flour, a powder, a meal, ground grains, a cake (such as, for example, a defatted or de-oiled cake). In a most preferred embodiment, the protein-rich concentrates are prepared from peas of cowpea plant.

In an embodiment, the cowpea-derived protein-rich concentrates exhibit organoleptic properties and taste as that of the normal egg and/or egg-white, while devoid of the undesired organoleptic properties of source including aroma and taste of the peas.

In an embodiment, the “cowpea-derived protein-rich concentrates” are suitable for various edible compositions and can be been incorporated into, egg-based products including but not limited to edible egg-free emulsion, egg analog, egg-free scrambled eggs, egg-free patty, egg-free pound cake, egg-free angel food cake, egg-free yellow cake, egg- and dairy-free cream cheese, egg-free pasta dough, egg-free custard, egg-free ice cream, and dairy-free milk and the like.

In an embodiment of the present invention, the “cowpea-derived protein-rich concentrates” are suitable for use as plant-based whole egg and/or egg-white substitutes for consumable products including but not limited to cream cheese, pasta dough, pasta, milk or milk-like beverage, a food product comprising said milk or milk-like beverage, custard, ice cream, frozen dessert, meat replicas (e.g., deli meat replicas; emulsified extruded meats (e.g., sausages, fish cake replicas); dips, fillings and spreads, chips, and crackers and the like.

In an embodiment of the present invention, the “cowpea-derived protein-rich concentrates” comprising one or more desirable food qualities, including but limited to, high protein content, low cholesterol content, reduced retention of oils and lipids, superior structure building properties such as high gel strength and gel elasticity, superior sensory properties, and selective enrichment of highly functional albumin and globulin proteins.

In an embodiment of the present invention, the cowpea-derived protein-rich concentrates have one or more functional properties by itself or when incorporated into a composition. Such functional properties may include, but are not limited to, one or more of emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color.

In an embodiment of the present invention, provided herein is a meat substitute comprising of a cowpea protein-rich concentrate described herein. In some embodiments, the meat substitute comprises one or more additional components selected from water, oil, palate enhancers, starch, salt and the like.

In a preferred embodiment of the present invention, cowpea protein-rich concentrate is present with a quantity between 0.5 and 70 wt. %, preferably from 0.5 to 10 wt. %, more preferably from 1% to 7 wt. % based on the total weight of the product, such as for instance at least 0.5 wt. %, for example at least 0.6 wt. %, for example at least 0.7 wt. %, for example at least 0.8 wt. %, for example at least 0.9 wt. %, for example at least 1.0 wt. %, for example at least 1.1 wt. %, for example at least 1.2 wt. %, for example at least 1.3 wt. %, for example at least 1.4 wt. %, for example at least 1.5 wt. %, for example at least 1.6 wt. %, for example at least 1.7 wt. %, for example at least 1.8 wt. %, for example at least 1.9 wt. %, for example at least 2.0 wt. %, for example at least 2.1 wt. %, for example at least 2.2 wt. %, for example at least 2.3 wt., for example at least 2.4 wt. %, for example at least 2.5 wt. %, for example at least 2.6 wt. %, for example at least 2.7 wt. %, for example at least 2.8 wt. %, for example at least 2.9 wt. %, for example at most 10 wt. %, for example at most 5 wt. %, for example at most 4.5 wt. %, for example at most 4 wt. %, for example at most 3 wt. %, for examples at most 2 wt. %, based on the total weight of the product.

In a preferred embodiment of the present invention, the edible products produced using cowpea protein-rich concentrate is substantially free of egg product. In some embodiments, the edible products contain less than 1 wt % of egg white based on the total weight of the product. In a preferred embodiment, the edible product is egg-free.

In another aspect of the present invention, the present disclosure relates to a method of manufacturing plant-based whole egg and/or egg-white substitute from cowpea comprising the steps of
a) soaking the whole cow pea pulse/cow pea pulse flour/cow pea pulse dehulled flour is soaked in water (1-10% w/v) for 10 min-1 day with/without continuous stirring at a pH of about 4-8 and temperature at about 2 to 65 deg C.;
b) draining or filtering to remove water;
c) grinding the components from step b) using a grinder;
d) mixing the ground materials with water (1-10% w/v) in a tanker of suitable capacity with rpm of 1000 to 5000 rpm, followed by continuous stirring for 1-6 h (preferably 6 h) at a pH of about 4-8 (preferably 7) and temperature at about 2 to 65 deg C. (preferably 65 deg C.);
e) ultracentrifugation of the resulting components at 1000-10000 rpm;
f) ultrafiltering the settled components from ultracentrifugation are using 10-100 micron mesh filters (preferably 50 micron mesh);
g) freeze or spray drying the filtered components to obtain the cow-pea protein concentrates.

In an embodiment of the present invention, the extraction step involves aqueous solution based extraction of the starting material. Most preferably, aqueous solution is water of any quality, for example soft-water, hard-water, distilled water and the like.

In an embodiment of the present invention, the extraction is performed at desired pH, temperature and other related extraction conditions. In a preferred embodiment, the desired temperature ranging from 2-60 deg C. and the pH ranging between 5.0-10.0, wherein the pH is the desired solubilization pH of the target protein-rich concentrates for example, neutral pH.

In some embodiments of the present invention, a plant-derived protein-rich concentrate comprising polypeptide or protein may be rendered substantially free of naturally associated components including fiber and starch, using protein purification techniques known in the art. In a preferred embodiment, separation may be performed by size exclusion such as using a mesh, screen, perforated surface, or other device capable of excluding objects of a certain size; separation based on hydrophobicity or other attractive forces; and separation by mass or density differentials for example, using a centrifuge, or using solutions for differential settling; and the like

In some embodiments of the present invention, a plant-derived protein-rich concentrate comprising polypeptide or protein may be purified using protein purification techniques known in the art. In a preferred embodiment, protein-rich concentrates of the present inventions may be purified by filtration, ultrafiltration, centrifugation, microfiltration, chromatographic techniques including affinity, membrane, column chromatography and the like.

In some embodiments of the present invention, plant-derived protein-rich concentrate solution comprising protein or polypeptide may be concentrated, using protein concentration techniques known in the art. In a preferred embodiment, protein-rich concentrates of the present inventions may be concentrated using techniques including but not limited to membrane based techniques such as membrane filtration, differential pressure concentration and the like.

In some embodiments of the present invention, plant-derived protein-rich concentrate solution may be dried using techniques known in the art. In a preferred embodiment, drying may involve techniques including spray drying, freeze drying, vacuum drying, hot air drying, microwave vacuum drying, vacuum freeze drying, nanospray drying, spray freeze drying and the like.

In a most preferred embodiment of the present invention, plant-derived protein-rich concentrate solution may be dried using spray drying, which comprises spraying of the protein-rich concentrate solution into air by atomization at elevated temperatures, wherein the said temperature ranges from 20-150 deg C.

In an aspect of the present invention, the purified plant-derived protein-rich concentrates may be reconstituted in suitable liquid, for example water, milk or any other liquids to form compositions suitable for the consumption or preparing edible product.

In some embodiments of the present invention, the compositions can be used as a replacement for whole eggs, egg-yolks, or egg-whites in edible and non-edible products.

In some embodiments of the present invention, the edible products can be baked goods such as but not limited to muffins, cakes, cupcakes, brownies, cookies, biscotti, pancakes, breads, waffles, pastries, pies, tarts, scones, pretzels, crackers and the like.

In an embodiment, the present disclosure focuses on a plant-derived protein-rich concentrates particularly for replacing part or all of the egg or egg powder in recipes for bakery products. Preferably the egg substitute is used to replace any egg and/or egg powder completely.

In an embodiment, the present disclosure focuses on a plant-derived protein-rich concentrates particularly for replacing part or all of the egg white or egg white powder in recipes for bakery products. Preferably the egg substitute is used to replace any egg and/or egg powder completely.

In some embodiments of the present invention, the edible products can include but not limited to pasta, noodles, meatloaf burgers, custards, sauces, ice cream, mayonnaise, and/or salad dressings.

In some embodiments of the present invention, the edible products can be meat products including but not limited to meat replicas (e.g., deli meat replicas; emulsified extruded meats (e.g., sausages, fish cake replicas); dips, fillings and spreads, chips, and crackers and the like.

In some embodiments of the present invention, the non-edible products include but not limited to pharmaceutical and cosmetic preparations such as shampoos, facial washes or masks, creams, films, encapsulates and the like. In other embodiments, the compositions can be used for functions other than as an egg substitute.

While the foregoing describes various embodiments of the disclosure, other and further embodiments of the disclosure may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

The present disclosure is further explained in the form of following examples. However, it is to be understood that the foregoing examples are merely illustrative and are not to be taken as limitations upon the scope of the invention. Various changes and modifications to the disclosed embodiments will be apparent to those skilled in the art. Such changes and modifications may be made without departing from the scope of the invention.

### Example 1: Preparation of Scrambled Food Preparation from Cowpea-Derived Protein-Rich Concentrate

Protein-rich concentrate mixed with water (1:1 ratio), chopped onions (3 table spoons), chopped green chilly (1 table spoon), black pepper powder (1 gram), taste enhancers (0.2 gram), salt to taste (1 gram).

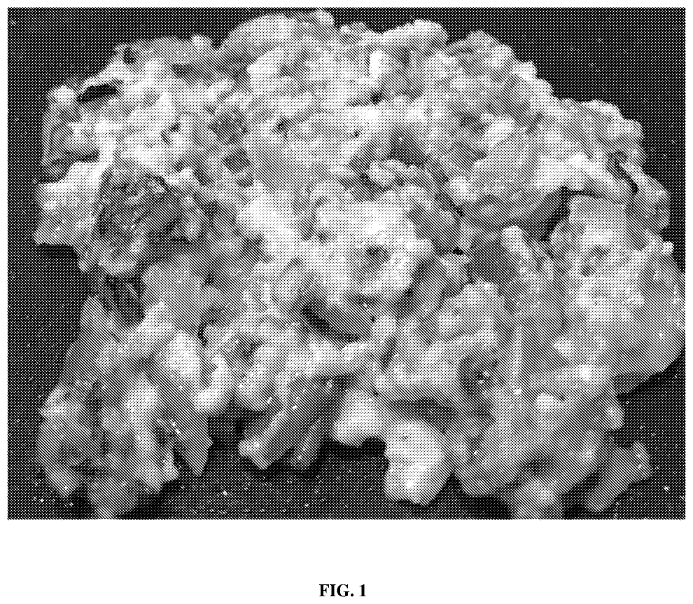

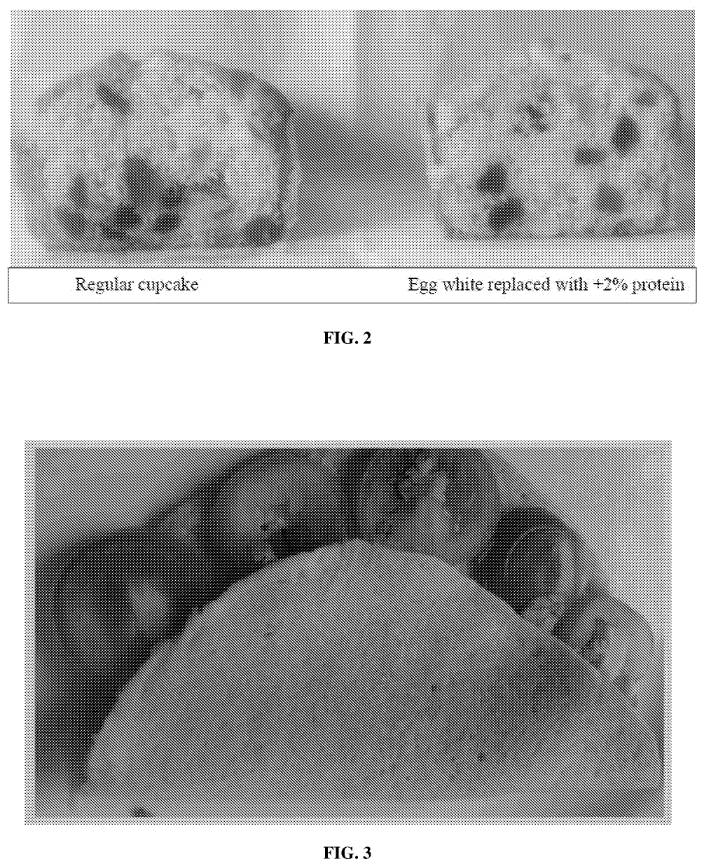

FIG. 1 represents the scrambled food product prepared using cow pea protein concentrate. The components are mixed well in a container using whisker for 30 seconds. The contents are cooked in a non-stick pan at ambient heat (low flame) with constant mixing.

The Scrambled food product prepared was tested for the taste and texture. The preparation tasted similar to the scrambled egg preparation made from egg white.

### Example 2: Preparation of Cupcake Using Cowpea-Derived Protein-Rich Concentrate

Protein-rich concentrate (2%) was mixed with cupcake composition. The composition was allowed to bake at ambient conditions.

The cupcake was tested for the palate, texture and softness. The preparation tasted similar to the cupcake preparation made using egg white.

### Example 3: Preparation of Omelet Using Cowpea-Derived Protein-Rich Concentrate

20 gram of cow pea protein concentrate added to (20 to 80 ml) water, chopped onions (3 table spoons), chopped green chilly (1 table spoon), black pepper powder (1 gram), taste enhancers (0.2 gram), salt to taste (1 gram).
Mixed well
Sprinkle oil to non-stick pan if required
Cooked to omelet consistency on non-stick pan on medium flame.

FIG. 3 represents the omelet prepared using cow pea protein concentrate.

The omelet prepared was tested for the taste and texture. The preparation tasted similar to omelet made from egg white.

### Example 4: Foaming Properties of Cupcake Using Cowpea-Derived Protein-Rich Concentrate

4 gram of cow pea protein concentrate added to 96 ml of water and hand beaten like egg to obtain foam.

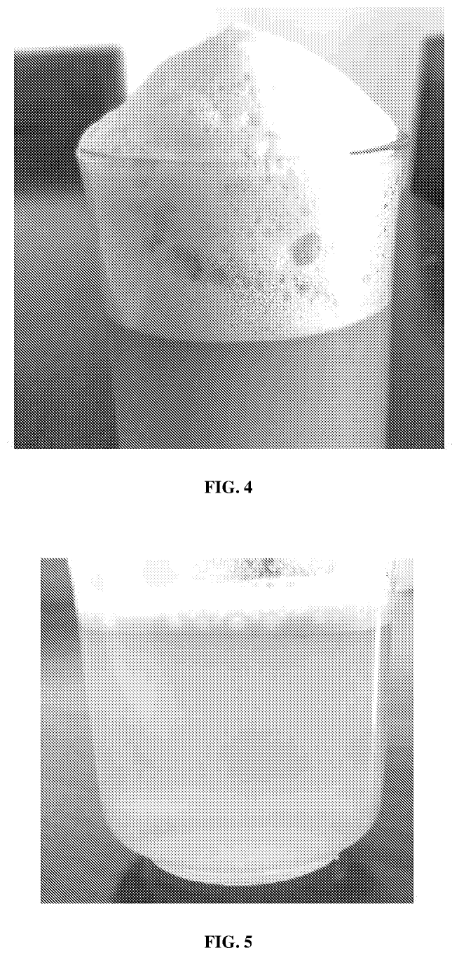

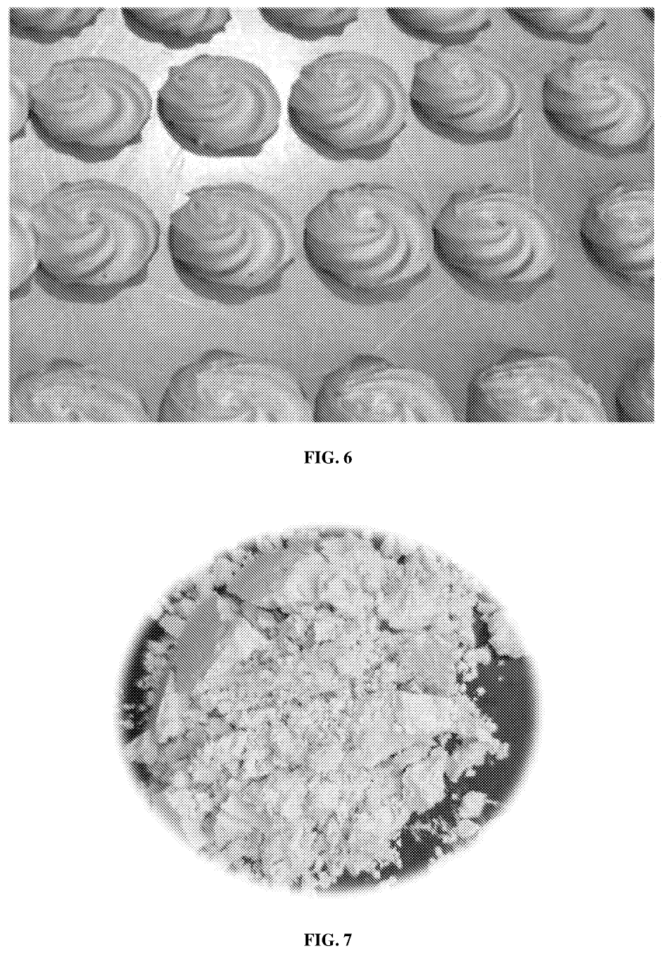

FIG. 4 represents the functionality and foaming capability of cow pea protein concentrate.

### Example 5: Solubility Properties of Cupcake Using Cowpea-Derived Protein-Rich Concentrate

2 gram of cow pea protein concentrate added to 98 ml of water and stirred well.

FIG. 5 represents functionality and solubility of cow pea protein concentrate in water.

### ADVANTAGES OF THE PRESENT INVENTION

The present disclosure provides a plant-based egg-white substitute that satisfies the existing needs, as well as others, and generally overcomes the deficiencies found in the prior art.

The present disclosure provides a plant-based whole egg and/or egg-white substitute that provides food-safe compositions that notonly resemble organoleptic properties of the normal egg but also reduces the disadvantages associated with the normal eggs such as allergic reactions, increased cardiovascular risk and the like.

The present disclosure provides a plant-based whole egg and/or egg-white substitute that alleviates the allergic reactions associated with the allergens that are generally found in the normal eggs.

The present disclosure provides a plant-based whole egg and/or egg-white substitute that has reduced cholesterol levels and higher protein levels than the normal eggs.

The present disclosure provides a plant-based whole egg and/or egg-white substitute that provides vegan alternatives to conventional animal-based products making them consumable by all kinds of consumers.

The present disclosure provides a method for manufacturing a plant-based whole egg and/or egg-white substitute from cowpea that is efficient as well as economical.

The present disclosure provides a method for manufacturing a plant-based whole egg and/or egg-white substitute from cowpea that drastically reduces the costs as well as the infrastructure required for producing normal eggs.

The present disclosure provides a method of manufacturing a plant-based whole egg and/or egg-white substitute from cowpea that drastically reduces pollutions associated with the poultry industry.

I claim:

1. A plant-derived protein-rich egg substitute comprising from about 0.5% to about 5% cowpea-derived protein-rich concentrates,
characterized in that:
the protein-rich concentrates has undenatured protein isolates from cowpea.

2. The egg substitute as claimed in claim 1, wherein the substitute is whole egg or egg white substitute.

3. The egg substitute as claimed in claim 1, wherein the substitute is meat substitute.

4. An edible product comprising the egg substitute as claimed in claim 1.

5. The edible product as claimed in claim 4, wherein the product is substantially free of egg white comprising cowpea-derived protein-rich concentrates.

6. The egg substitute as claimed in claim 1, wherein the egg replacement composition is combined with natural egg white.

7. A method of manufacturing plant-based egg substitute as claimed in claim 1 comprising the steps of:
a) soaking the whole cow pea pulse/cow pea pulse flour/cow pea pulse dehulled flour is soaked in suitable amount of water for 1 day with/without continuous stirring at a suitable pH and suitable temperature;
b) draining or filtering to remove water;
c) grinding the components from step b) using a grinder;
d) mixing the ground materials with suitable amount of water in a tanker of suitable capacity with rpm ranging from about 1000 to about 5000 rpm, followed by continuous stirring for 1-6 h at suitable pH and suitable temperature;
e) ultracentrifugation of the resulting components at 1000-10000 rpm;
f) ultrafiltering the settled components from ultracentrifugation using 10-100 micron mesh filters;
g) freeze or spray drying the filtered components to obtain the cow-pea protein concentrates.

8. The method as claimed in claim 7, wherein the suitable amount of water ranges ranging from about 1 to about 10% w/v.

9. The method as claimed in claim 7, wherein the suitable pH ranges from about 4 to about 8.

10. The method as claimed in claim 7, wherein the suitable temperature ranges from about 20 to about 65 deg C.
